(19) United States
(12) Patent Application Publication
(10) Pub. No.: US 2012/0180594 A1
(43) Pub. Date: Jul. 19, 2012

(54) ELECTRIC TILT STEERING APPARATUS FOR VEHICLE

(75) Inventor: Seok PARK, Seoul (KR)

(73) Assignee: Mando Corporation

(21) Appl. No.: 13/295,344

(22) Filed: Nov. 14, 2011

(30) Foreign Application Priority Data
Jan. 17, 2011 (KR) 10-2011-0004418

(51) Int. Cl. B62D 1/187; B62D 1/181

(52) U.S. Cl. 74/493

(57) ABSTRACT

An electric tilt steering apparatus for a vehicle can reduce the vibration and noise generated by the axial and radial clearance between a tilt screw and surrounding parts supporting the tilt screw, so as to maintain the rigidity and improve the durability. Further, the electric tilt steering apparatus according to the present invention can simplify the assembling process, reduce the assembling steps, and provide a driver with a comfortable operation feeling during the tilt operation.

### CROSS-REFERENCE TO RELATED APPLICATION

This application claims priority from and the benefit under 35 U.S.C. §119(a) of Korean Patent Application No. 10-2011-0004418, filed on Jan. 17, 2011, which is hereby incorporated by reference for all purposes as if fully set forth herein.

### BACKGROUND OF THE INVENTION

1. Field of the invention

The present invention relates to a steering apparatus of a vehicle. More particularly, the present invention relates to an electric tilt steering apparatus for a vehicle, which can reduce the vibration and noise generated by the axial and radial clearance between a tilt screw and surrounding parts supporting the tilt screw, so as to maintain the rigidity and improve the durability, and can simplify the assembling process, reduce the assembling steps, and provide a driver with a comfortable operation feeling during the tilt operation.

2. Description of the Prior Art

As generally known in the art, a steering apparatus of a vehicle is an apparatus for changing the direction of progress of the vehicle according to the driver's intention, i.e. an auxiliary apparatus which optionally changes the rotation center around which front wheels of a vehicle turn, thereby enabling the vehicle to progress in a direction desired by a driver.

In the steering apparatus as described above, a steering force generated by a driver's handling of a steering wheel is transferred through a steering shaft to a rack-pinion mechanism at the lower side, which finally changes the direction of the wheels of both sides.

The steering apparatus as described above has a tilt or telescope function, by which the driver can control a degree of protrusion or an inclination angle of the steering wheel based on the height or physical condition of the driver, so that the driver can perform a steering operation in a smooth and easy manner.

Further, for the tilt or telescope function, the initially employed operation scheme was a manual operation scheme, in which the driver handles an operation lever by himself or herself to move the steering wheel in an axial direction or rotate the steering wheel about a hinge axis. However, an automatic operation scheme using a motor was developed later.

An electric tilt steering apparatus can be divided into an upper tilt steering apparatus and a lower tilt steering apparatus according to whether the hinge part, which serves as a rotation shaft at the time of tilt operation, is located at the upper end part or the lower end part of a steering column.

FIG. 1 is a partly enlarged perspective view of a conventional electric tilt steering apparatus of a vehicle.

As shown in FIG. 1, the conventional electric tilt steering apparatus of a vehicle includes a steering shaft 101 connected to a steering wheel (not shown) of a vehicle, a column housing 103 surrounding the steering shaft 101, a tilt bracket 105 formed at the rear end of the column housing 103, a rotation member 107 rotatably assembled with an inner part of the tilt bracket 105, a tilt driving shaft 109 rotatably assembled with an upper part of the tilt bracket 105, a tilt motor 111 formed at one side of the column housing 103, a driving gear 113 driven by the tilt motor 111, and a medium gear 115 engaged with both the driving gear 113 and the tilt driving shaft 109.

In the conventional electric tilt steering apparatus having the construction described above, when a driver operates a tilt switch (not shown), the tilt motor 111 operates, so that the driving force of the tilt motor 111 rotates the tilt driving shaft 109 through the driving of the driving gear 113 and the medium gear 115. The rotation of the tilt driving shaft 109 causes the driving shaft coupling part 117 to move forward or backward. However, since the rotation member 107 has been assembled with the hinge shaft 119 of the tilt bracket 105, the rotation member 107 rotates a predetermined angle about the hinge shaft 119, thereby performing the tilt function. Further, during this procedure, the driving shaft coupling part 117 rotates a predetermined angle with respect to the rotation member 107, thereby helping the smoother tilt operation.

However, the conventional electric tilt steering apparatus is problematic in that the axial clearance and radial clearance between the tilt screw and peripheral parts supporting the tilt screw may generate noise during the tilt operation and degrade the durability.

Further, a big noise or operation sound, which may be generated by related parts during the tilt operation, may make the driver feel unpleasant to disturb the driving.

### SUMMARY OF THE INVENTION

Accordingly, the present invention has been made to solve the above-mentioned problems occurring in the prior art, and an object of the present invention is to provide an electric tilt steering apparatus for a vehicle, which can reduce the vibration and noise generated by the axial and radial clearance between a tilt screw and surrounding parts supporting the tilt screw, so as to maintain the rigidity and improve the durability, and can simplify the assembling process, reduce the assembling steps, and provide a driver with a comfortable operation feeling during the tilt operation.

In accordance with an aspect of the present invention, there is provided an electric tilt steering apparatus including: a tilt housing in which a worm wheel reducer and a tilt screw for tilt operation are mounted, the tilt housing being assembled with an electric motor; a supporting member having an inner circumference coupled with the tilt screw and an outer circumference supported by an inner side of the tilt housing; a first bearing disposed between a first side of the worm wheel reducer and the supporting member; a second bearing tightly fitted around the tilt screw at a second side of the worm wheel reducer; and a fastening member supporting an end of the second bearing and coupled with an inner part of the tilt housing.

In accordance with another aspect of the present invention, there is provided an electric tilt steering apparatus including: a tilt housing in which a worm wheel reducer and a tilt screw for tilt operation are mounted, the tilt housing being assembled with an electric motor; a first bearing having a first side surface supported by an outer side of the tilt housing and coupled with an outer circumference of the tilt housing; a holding member supporting a second side surface of the first bearing and coupled with an end part of the tilt screw; a supporting member disposed between the first bearing and the worm wheel reducer and having an inner circumference coupled with the tilt screw and an outer circumference supported by an inner side of the tilt housing; a second bearing tightly fitted around the tilt screw at one side of the worm wheel reducer opposite to the first bearing; and a fastening member supporting an end of the second bearing and coupled with an inner part of the tilt housing.

An electric tilt steering apparatus for a vehicle according to the present invention having the construction and shape as described above can reduce the vibration and noise generated by the axial and radial clearance between a tilt screw and surrounding parts supporting the tilt screw, so as to maintain the rigidity and improve the durability. Further, the electric tilt steering apparatus according to the present invention can simplify the assembling process, reduce the assembling steps, and provide a driver with a comfortable operation feeling during the tilt operation.

### BRIEF DESCRIPTION OF THE DRAWINGS

The above and other objects, features and advantages of the present invention will be more apparent from the following detailed description taken in conjunction with the accompanying drawings, in which:

FIG. 1 is a partly enlarged perspective view of a conventional electric tilt steering apparatus of a vehicle;

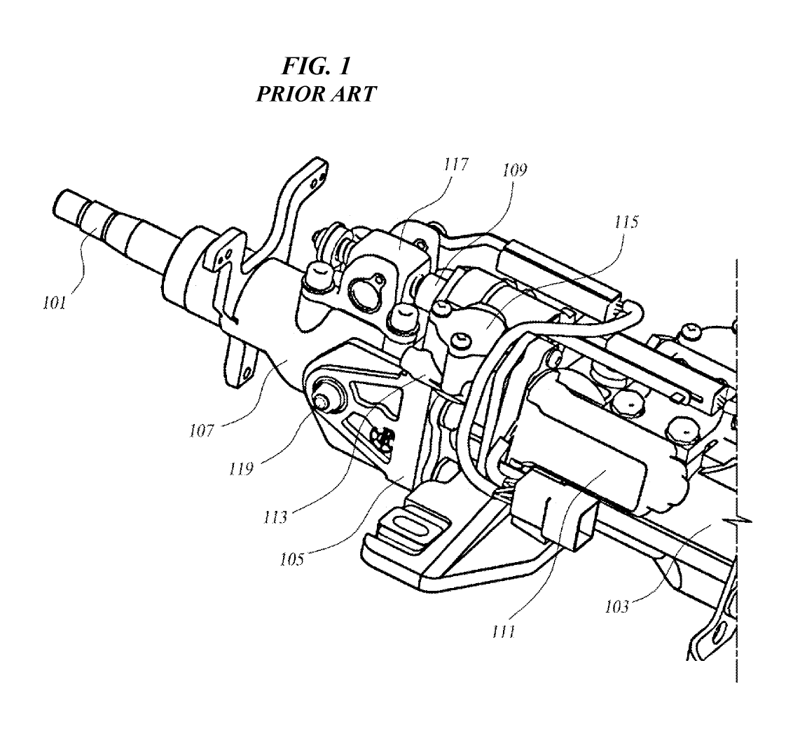

FIG. 2 is a perspective view of an electric tilt steering apparatus of a vehicle according to an embodiment of the present invention;

FIG. 3 is a side view of an electric tilt steering apparatus of a vehicle with a telescope operation part according to an embodiment of the present invention;

FIG. 4 is a sectional view of an electric tilt steering apparatus of a vehicle according to a first embodiment of the present invention; and

FIG. 5 is a sectional view of an electric tilt steering apparatus of a vehicle according to a second embodiment of the present invention.

### DETAILED DESCRIPTION OF THE EXEMPLARY EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is “connected,” “coupled” or “joined” to another component, a third component may be “connected,” “coupled,” and “joined” between the first and second components, although the first component may be directly connected, coupled or joined to the second component.

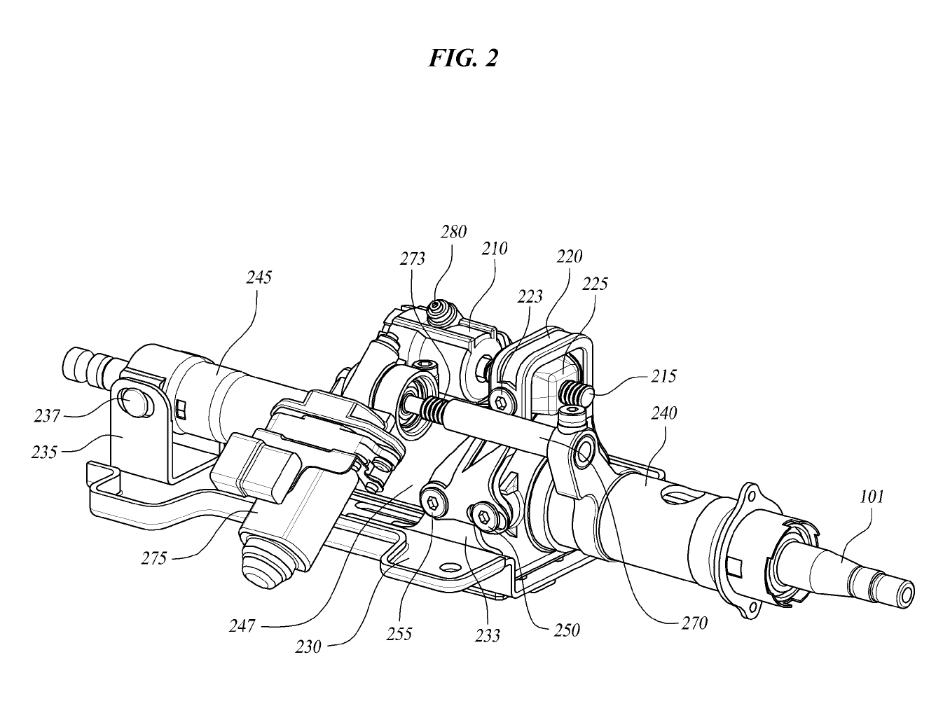

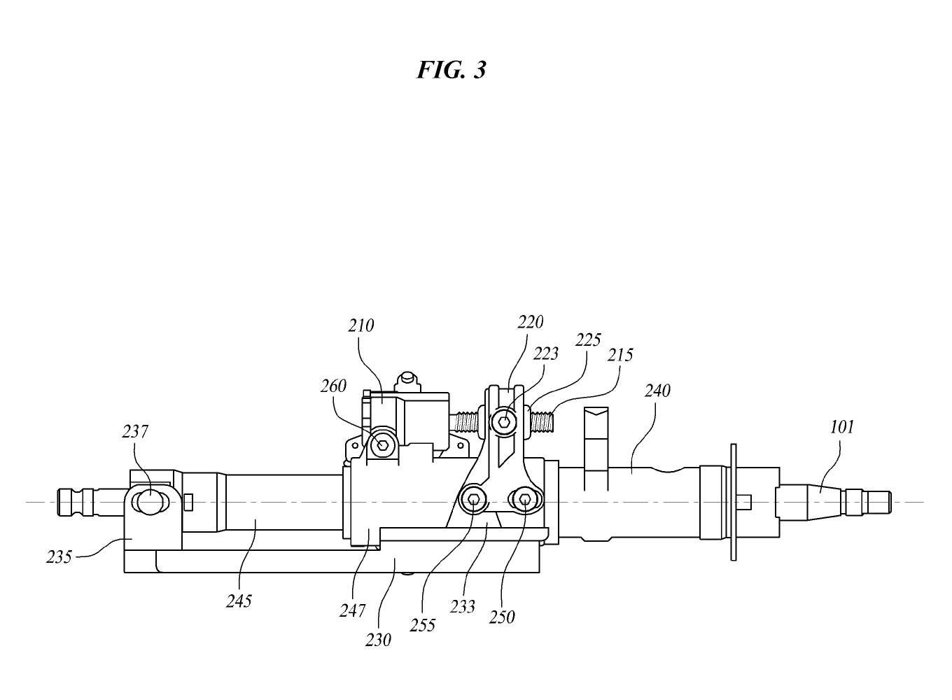

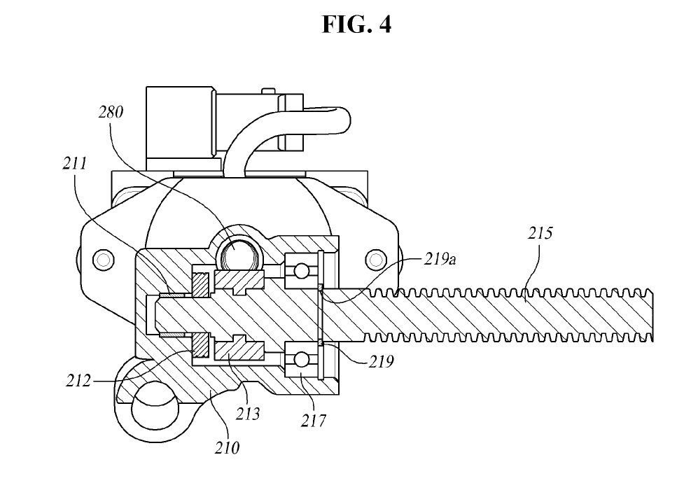

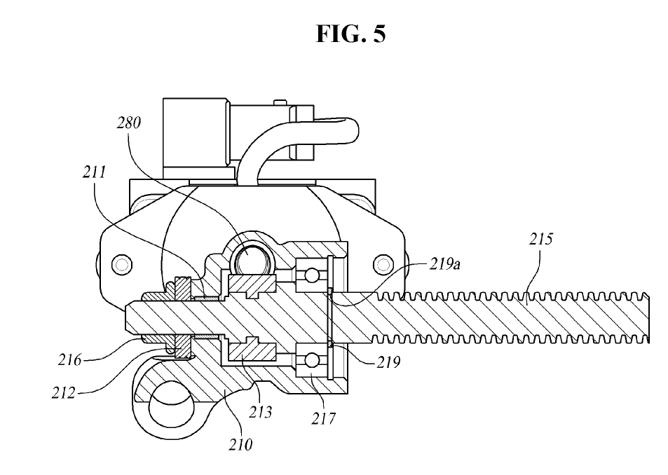

FIG. 2 is a perspective view of an electric tilt steering apparatus of a vehicle according to an embodiment of the present invention, FIG. 3 is a side view of an electric tilt steering apparatus of a vehicle with a telescope operation part according to an embodiment of the present invention, FIG. 4 is a sectional view of an electric tilt steering apparatus of a vehicle according to a first embodiment of the present invention, and FIG. 5 is a sectional view of an electric tilt steering apparatus of a vehicle according to a second embodiment of the present invention.

As shown in the figures, the electric tilt steering apparatus according to the first embodiment of the present invention includes a tilt housing 210 assembled with an electric motor and accommodating a worm wheel reducer 213 and a tilt screw 215 for a tilt operation therein, a supporting member 211 having an inner circumferential side coupled with the tilt screw 215 and an outer circumferential side supported by the inner side of the tilt housing 210, a first bearing 212 disposed between one side of the worm wheel reducer 213 and the supporting member 211, a second bearing 217 tightly fitted around the tilt screw 215 at the other side of the worm wheel reducer 213, and a fastening member 219 supporting an end of the second bearing 217 and coupled with an inner part of the tilt housing 210.

Further, the electric tilt steering apparatus according to the second embodiment of the present invention includes a tilt housing 210 assembled with an electric motor and accommodating a worm wheel reducer 213 and a tilt screw 215 for a tilt operation therein, a first bearing 212 having one side surface supported by an outer side of the tilt housing 210 and coupled with an outer circumference of the tilt housing 210, a holding member 216 supporting the other side surface of the first bearing 212 and coupled with an end part of the tilt screw 215, a supporting member 211 disposed between the first bearing 212 and the worm wheel reducer 213 and having an inner circumferential side coupled with the tilt screw 215 and an outer circumferential side supported by the inner side of the tilt housing 210, a second bearing 217 tightly fitted around the tilt screw 215 at the other side of the worm wheel reducer 213, and a fastening member 219 supporting an end of the second bearing 217 and coupled with an inner part of the tilt housing 210.

In the first and second embodiments of the present invention, the worm wheel reducer 213 reduces the rotation speed of the electric motor operated when the driver operates the tilt switch, and thus increases the rotation force of the electric motor. The worm wheel reducer 213 is mounted in the tilt housing 210, the outer circumferential part of the worm wheel reducer 213 has teeth engaged with a worm 280 coupled with the motor, and the inner circumferential part of the worm wheel reducer 213 is coupled with the tilt screw 215 so as to rotate the tilt screw 215 by the reduction ratio of the worm 280 and the worm wheel.

The tilt housing 210, in which the worm wheel reducer 213 is installed, has a housing hinge part 260, which is provided at a portion of an outer side of the steering column and is hingedly assembled with a column housing 247. Therefore, at the time of tilt operation, the tilt housing 210 rotates, together with the broadcast data generator 220, around the housing hinge part 260.

That is, at the time of tilt operation, the tilt housing 210 also rotates about the housing hinge part 260 so that the tilt screw 215 and a nut 225 hingedly coupled with a tilt bracket 220 rotating about an upper hinge part 255 can be rightfully engaged with each other.

The steering shaft 101 extends through and is assembled with the column housing 247, an upper tube 240 is inserted through and assembled with an inner upper portion of the column housing 247, a bush and a lower tube 245 are inserted through and assembled with an inner lower portion of the column housing 247, and the lower tube 245 is then connected to the upper hinge part 255 of the tilt bracket 220. The column housing 247 is coupled through the upper hinge part 255 with an upper bracket 233 assembled with a mounting bracket 230 fixed to a chassis of the vehicle.

A lower bracket 235 is hingedly assembled through a lower hinge part 237 with opposite sides of a lower tube 245 and is fixed to the mounting bracket 230. The lower hinge part 237 serves as a rotation axis for the steering column cooperating with the tilt bracket 220 at the time of tilt operation.

The mounting bracket 230 fixes the steering column to a chassis of the vehicle. The mounting bracket 230 has an upper side assembled with the upper bracket 233 and a lower side assembled with the lower bracket 235 so that the mounting bracket 230 firmly supports the steering column.

Meanwhile, the tilt screw 215 performs a relative rotation independently from the tilt bracket 220. Therefore, without a rotation of the tilt bracket 220, the tilt screw 215 can be engaged with the nut 225 at a rightful position.

The tilt screw 215 rotates around the central axis of the tilt screw 215 by the worm wheel reducer 213 engaged with the worm 280 at the time of operation of the motor. At this time, during the rotation of the tilt screw 215, the nut 225 engaged with the tilt screw 215 performs a linear movement along the screw of the tilt screw 215 while causing a rotational displacement of the tilt bracket 220 supported by the nut 225.

Further, the tilt bracket 220 generally surrounds the column housing 247. The tilt bracket 220 includes a nut hinge part 223 hingedly coupled with the nut 225 engaged with the tilt screw 215 so that the nut hinge part 223 can rotate in the progress direction of the nut 225 at the time of tilt operation, a column support part 250 coupled with the column housing 247, and an upper hinge part 255 hingedly coupled with the upper bracket 233 fixed to the mounting bracket 230.

Therefore, at the time of tilt operation, the tilt bracket 220 rotates in the progress direction of the nut 225 around the upper hinge part 255 while rotating the steering column supported by the column support part 250.

That is, when the tilt bracket 220 rotates around the upper hinge part 255, the steering column also rotates. Since the steering column is fixed to the column support part 250 and the lower hinge part 237, the tilt operation is performed while the entire steering column rotates around the lower hinge part 237.

When the tilt operation is performed in this way, the tilt screw 215 rotates and the clearance between the tilt screw 215 and surrounding parts supporting the tilt screw 215 causes vibration and noise.

Therefore, according to the first embodiment of the present invention as shown in FIG. 4, the first bearing 212 and the supporting member 211 are sequentially assembled at one side of the worm wheel reducer 213 corresponding to the side of the end of the tilt screw 215, and the second bearing 217 and the fastening member 219 are sequentially assembled at the other side of the worm wheel reducer 213 corresponding to the direction in which the nut 225 is assembled, so as to reduce the vibration and noise and thereby reinforce the rigidity.

The inner circumferential surface of the supporting member 211 fitted around the end part of the tilt screw 215 is in tight contact with the outer circumferential surface of the tilt screw 215 and the outer circumferential surface of the supporting member 211 is supported by and in tight contact with the inner circumferential surface of the tilt housing 210, so as to prevent the vibration and noise in the axial direction and the circumferential direction.

The supporting member 211 is usually made by weaving steel wires, although it may be made from an elastic material, such as rubber or plastic.

The first bearing 212 is disposed between one side of the worm wheel reducer 213 and the supporting member 211, so as to support a load in the axial direction when the tilt screw 215 rotates. It is preferred that the first bearing 212 is a thrust bearing, especially a needle thrust bearing.

Further, the second bearing 217 tightly fitted around the tilt screw 215 at the other side of the worm wheel reducer 213 supports a load in the radial direction when the tilt screw 215 rotates. It is preferred that the second bearing 217 is a ball bearing.

The fastening member 219 is in contact with and supports the side surface or the end part of the second bearing 217, and is coupled with the inner surface of the tilt housing 210, so as to remove the axial clearance of the second bearing 217 and prevent the axial movement and vibration of the tilt screw 215.

The fastening member 219 has a shape of a partly-cutout ring, and is in tight contact with and coupled with the outer circumference of the tilt screw 215 by the elastic force in the radial direction of the ring-shaped fastening member 219. The tilt screw 215 has a ring-shaped seating groove 219a formed on the outer circumference of the tilt screw 215, in which the fastening member 219 is seated.

As a result, according to the first embodiment of the present invention, the first bearing 212 and the second bearing 217 at both sides of the worm wheel reducer 213 support the load in the axial direction and radial direction, so as to suppress the vibration and thereby maintain the rigidity in the axial direction and the radial direction.

Further, the assembling of the electric tilt steering apparatus can be completed simply by coupling the supporting member 211, the first bearing 212, the second bearing 217, and the fastening member 219 with the tilt screw 215 and then coupling the tilt screw 215 with the tilt housing 210. Therefore, the assembling process is simple and easy.

Meanwhile, according to the second embodiment of the present invention as shown in FIG. 5, the supporting member 211, the first bearing 212, and the holding member 216 are sequentially assembled at one side of the worm wheel reducer 213 corresponding to the side of the end of the tilt screw 215, and the second bearing 217 and the fastening member 219 are sequentially assembled at the other side of the worm wheel reducer 213 corresponding to the direction in which the nut 225 is assembled, so as to reduce the noise.

The first bearing 212 fitted around the outer circumference of the tilt screw 215 is exposed to the exterior of the tilt housing 210, differently from the first embodiment of the present invention. The first bearing 212 has one side surface supported by an outer surface of the tilt housing 210, and is in tight contact with the tilt housing 210 and tightly supported by the holding member 216.

The holding member 216 supports the other surface of the first bearing 212 toward the tilt housing 210 and is assembled with the end part of the tilt screw 215. The holding member 216 is screw-assembled with the tilt screw 215, so as to adjust the support force for supporting the other surface of the first bearing 212.

Therefore, it is possible to adjust the assembling force of the holding member 216 according to the kind of vehicle by using a tool capable of setting the assembling force, such as a torque wrench.

Further, the supporting member 211 disposed between the first bearing 212 and the worm wheel reducer 213 has an inner circumferential side coupled with the tilt screw 215 and an outer circumferential side supported by the inner side of the tilt housing 210.

The supporting member 211 according to the second embodiment of the present invention has the same shape and function as those of the supporting member 211 according to the first embodiment of the present invention, only with the single difference in the position at which the supporting member 211 is assembled.

The second bearing 217 and the fastening member 219 sequentially assembled at the other side of the worm wheel reducer 213 according to the second embodiment of the present invention have the same assembling positions, shapes, and functions as those of the first embodiment of the present invention. The second bearing 217 supports the load in the radial direction at the time of rotation of the tilt screw 215, and the fastening member 219 supports the end of the second bearing 217 at one side of the second bearing 217 and is assembled with the outer circumference of the tilt screw 215.

Further, like the first embodiment of the present invention, the fastening member 219 has a shape of a partly-cutout ring, and is in tight contact with and coupled with the outer circumference of the tilt screw 215 by the elastic force in the radial direction of the ring-shaped fastening member 219. The tilt screw 215 has a ring-shaped seating groove 219a formed on the outer circumference of the tilt screw 215, in which the fastening member 219 is seated.

In the second embodiment of the present invention as described above, the supporting member 211 supported by the inside of the tilt housing 210 at one side of the worm wheel reducer 213 reduces the movement and vibration in the radial direction and axial direction, and the fastening member 219 assembled with the inside of the tilt housing 210 at the other side of the worm wheel reducer 213 supports the end part of the second bearing 217 so as to remove the axial clearance of the second bearing 217 and prevent the axial movement and vibration of the tilt screw 215.

As a result, according to the second embodiment of the present invention, the first bearing 212 and the second bearing 217 support the load in the axial direction and radial direction at both sides of the worm wheel reducer 213, so as to suppress the vibration and thereby maintain the rigidity in the axial direction and the radial direction.

Further, the assembling of the electric tilt steering apparatus can be completed simply by coupling the supporting member 211, the second bearing 217, and fastening member 219 with the tilt screw 215, coupling the tilt screw 215 with the tilt housing 210, and then coupling the first bearing 212 and the holding member 216 at the outside of the tilt housing 210. Therefore, the assembling process is simple and easy.

The electric tilt steering apparatus of a vehicle according to embodiments of the present invention may further include a telescope function configured by a telescope driving motor 275, a telescope screw 273, and a telescope nut 270, which has a construction similar to that of a conventional telescope steering apparatus, so a detailed description thereof is omitted here.

An electric tilt steering apparatus for a vehicle according to the present invention having the construction and shape as described above can reduce the vibration and noise generated by the axial and radial clearance between a tilt screw and surrounding parts supporting the tilt screw, so as to maintain the rigidity and improve the durability. Further, the electric tilt steering apparatus according to the present invention can simplify the assembling process, reduce the assembling steps, and provide a driver with a comfortable operation feeling during the tilt operation.

Even if it was described above that all of the components of an embodiment of the present invention are coupled as a single unit or coupled to be operated as a single unit, the present invention is not necessarily limited to such an embodiment. That is, among the components, one or more components may be selectively coupled to be operated as one or more units.

In addition, since terms, such as “including,” “comprising,” and “having” mean that one or more corresponding components may exist unless they are specifically described to the contrary, it shall be construed that one or more other components can be included. All of the terminologies containing one or more technical or scientific terminologies have the same meanings that persons skilled in the art understand ordinarily unless they are not defined otherwise. A term ordinarily used like that defined by a dictionary shall be construed that it has a meaning equal to that in the context of a related description, and shall not be construed in an ideal or excessively formal meaning unless it is clearly defined in the present specification.

Although an exemplary embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

What is claimed is:

1. An electric tilt steering apparatus comprising:
a tilt housing in which a worm wheel reducer and a tilt screw for tilt operation are mounted, the tilt housing being assembled with an electric motor;
a supporting member having an inner circumference coupled with the tilt screw and an outer circumference supported by an inner side of the tilt housing;
a first bearing disposed between a first side of the worm wheel reducer and the supporting member;
a second bearing tightly fitted around the tilt screw at a second side of the worm wheel reducer; and
a fastening member supporting an end of the second bearing and coupled with an inner part of the tilt housing.

2. An electric tilt steering apparatus comprising:
a tilt housing in which a worm wheel reducer and a tilt screw for tilt operation are mounted, the tilt housing being assembled with an electric motor;
a first bearing having a first side surface supported by an outer side of the tilt housing and coupled with an outer circumference of the tilt housing;
a holding member supporting a second side surface of the first bearing and coupled with an end part of the tilt screw;
a supporting member disposed between the first bearing and the worm wheel reducer and having an inner circumference coupled with the tilt screw and an outer circumference supported by an inner side of the tilt housing;
a second bearing tightly fitted around the tilt screw at one side of the worm wheel reducer opposite to the first bearing; and
a fastening member supporting an end of the second bearing and coupled with an inner part of the tilt housing.

3. The electric tilt steering apparatus as claimed in claim 2, wherein the holding member is screw-assembled with the tilt screw, so as to adjust a supporting force for supporting the second side surface of the first bearing.

4. The electric tilt steering apparatus as claimed in claim 1 or 2, wherein the first bearing is a thrust bearing.

5. The electric tilt steering apparatus as claimed in claim 1 or 2, wherein the second bearing is a ball bearing.

6. The electric tilt steering apparatus as claimed in claim 1 or 2, wherein the fastening member has a shape of a partly-cutout ring, and is in tight contact with and coupled with an inside of the tilt housing by an elastic force in a radial direction of the ring-shaped fastening member.
